(19) United States
(12) Patent Application Publication
(10) Pub. No.: US 2024/0393259 A1
(43) Pub. Date: Nov. 28, 2024

(54) PINHOLE DETECTION DEVICE

(71) Applicant: ENVICONS CO., LTD., Yongin-si (KR)

(72) Inventors: Byung Ki CHOI, Yongin-si (KR); Jae Koo CHOI, Incheon (KR); Jin Duk KIM, Uiwang-si (KR); Kyeong Li RYU, Seoul (KR)

(21) Appl. No.: 18/697,399

(22) PCT Filed: Sep. 20, 2022
(86) PCT No.: PCT/KR2022/014004

§ 371 Date: Mar. 29, 2024

(30) Foreign Application Priority Data
Sep. 30, 2021 (KR) 10-2021-0130178

(51) Int. Cl. G01N 21/894; G01N 21/89

(52) U.S. Cl. CPC G01N 21/894; G01N 21/8914

(57) ABSTRACT

A pin-hole detection device includes: a film supply unit provided with a roller on which the film is wound; a base part disposed adjacent to the film supply unit, seated on a ground, and formed by connecting a plurality of profiles; a light emitting unit mounted on the base part and emitting light; a film unwinding unit mounted on the base part, configured to unwind the film provided from the film supply unit, and allow the unwounded film to pass through the light emitting unit while being unfolded; and a luminous intensity measuring unit mounted on the base part and disposed to face the light emitting unit to measure the luminous intensity of light passing through the unfolded film, wherein the film unwinding unit includes a winder roller unit rotating and moving the film in one direction while compressing the film, and an idle roller unit rotated according to movement of the contacted film and configured to guide the unwound film to determine a movement path.

### CROSS REFERENCE TO RELATED APPLICATIONS

This application is a National Stage Entry of International Patent Application No. PCT/KR2022/014004, filed on Sep. 20, 2022, which claims priority from and the benefit of Korean Patent Application No. 10-2021-0130178, filed on Sep. 30, 2021, each of which is hereby incorporated by reference for all purposes as if fully set forth herein.

### BACKGROUND

### Field

The present invention relates to a pinhole detection device, and more particularly, to a pinhole detection device for detecting pinholes formed in a film.

### Discussion of Background

Lithium secondary batteries have been used in a wide range of electronic device markets, including smart IT devices and portable electronic devices, due to their advantages such as high energy density and output, non-memory effect, and long lifespan.

The lithium secondary battery is composed of a cathode, an anode, an electrolyte, and a separator. The required characteristics of the separator of the lithium secondary battery is to increase ionic conductivity by increasing permeability of lithium ions based on high porosity while separating the cathode from the anode to electrically insulate between the cathode and anode. In addition, the separator should have mechanical strength that may withstand external shocks or a high-speed winding process when assembling the battery, and the battery should not ignite or explode due to heat shrinkage of the separator due to overcharging, exposure to high temperature, or the like.

The separator, which is one of the four major components of the lithium secondary battery, is a film with fine pores of less than a micron (μm). The separator separates the cathode from the anode within the lithium secondary battery, thereby preventing the cathode and anode from electrical short-circuiting due to physical contact therebetween and enabling lithium ions to be moved through the electrolyte impregnated within the pores.

During the manufacturing process, pinholes larger than micropores may form in the separator, and the separator with the large pinholes may not completely isolate the cathode and anode in the lithium secondary battery, which may cause the short circuit.

Since the short circuit in the lithium secondary battery may lead to a fire or explosion, the process of detecting the pinholes in the separator is one of the very important processes.

### SUMMARY

It is an object of the present invention to provide a pinhole detection device capable of detecting pinholes formed in a film while maintaining tension of the film.

According to an embodiment of the present invention, a pinhole detection device for detecting pinholes formed in a film includes: a film supply unit that is provided with a roller on which the film is wound; a base part that is disposed adjacent to the film supply unit, seated on a ground, and formed by connecting a plurality of profiles; a light emitting unit that is mounted on the base part and emits light; a film unwinding unit that is mounted on the base part, unwinds the film provided from the film supply unit, and allows the unwounded film to pass through the light emitting unit while being unfolded; and a luminous intensity measuring unit that is mounted on the base part and disposed to face the light emitting unit to measure the luminous intensity of light passing through the unfolded film, wherein the film unwinding unit may include a winder roller unit that rotates and moves the film in one direction while compressing the film, and an idle roller unit that is rotated according to movement of the contacted film and guides the unwound film to determine a movement path.

The winder roller unit may include a compression roller unit that compresses the film, and a driving roller unit that is rotated by applied power while adhering to the compression roller unit to rotate the adhering compression roller unit, wherein the compression roller unit may have an interlocking roller that adheres to the driving roller unit and a moving roller that is disposed adjacent to the interlocking roller, and the moving roller may be moved so that a separation distance from the interlocking roller is changed to compress or decompress the film interposed between the moving roller and the interlocking roller.

In the pinhole detection device according to an embodiment of the present invention, the compression roller unit of may further include: a fixed part that is fixed to the base part; a position moving unit that is moved by the applied power while being mounted on the fixed part; and a space providing unit that is interlocked according to positional movement of the position moving unit while being connected to the position moving unit, and provides a space where a first rotation axis of the moving roller is mounted, wherein the moving roller may be moved by the position moving unit from a standby position disposed at a first separation distance from the interlocking roller to a compression position disposed at a second separation distance closer than the first separation distance, and a first straight line extending a positional movement direction of the position moving unit and a second straight line connecting the first rotation axis of the moving roller and a second rotation axis of the interlocking roller may form an acute angle.

In the pinhole detection device according to an embodiment of the present invention, the compression roller unit may further include guide parts that are fixed to the fixed part and are disposed on both sides of the position moving unit to guide positional movement of the space providing unit with respect to the fixed part, wherein the guide part may be composed of a main body part that is fixed to the fixed part and a rod part that is fixed to the space providing unit, and a length of the guide part may be changed according to insertion and de-insertion of the rod part into or from the main body part.

In the pinhole detection device according to an embodiment of the present invention, the idle roller unit may include: a first idle roller through which the film supplied from the film supply unit passes, and second idle rollers that are disposed on both sides of the light emitting unit and allows the film passing through the first idle roller to pass through an upper side of the light emitting unit while being unfolded, a height of a shaft of the first idle roller may be disposed lower than that of the film supply unit and lower than that of the second idle roller, with respect to the ground, and the unwound film from the film supply unit may be in contact with a lower side surface of the first idle roller and an upper side surface of the second idle roller.

In the pinhole detection device according to an embodiment of the present invention, the second idle roller may include a 2-1th idle roller that is disposed on one side of the light emitting portion in a width direction and a 2-2th idle roller that is disposed on the other side of the light emitting portion in the width direction, wherein the 2-1th idle roller and the 2-2th idle roller may be disposed at the same height, the compression roller unit may be disposed below the 2-2 idle roller, and the film supplied from the film supply unit may be compressed by the compression roller unit while passing through the first idle roller and the second idle roller to maintain tension.

In the pinhole detection device according to an embodiment of the present invention, the light emitting unit may be composed of a seating part that is seated on an upper surface of the base part and disposed between the 2-1th idle roller and the 2-2th idle roller and an LED unit built in the seating part, wherein the seating part may be formed higher than an upper end of the 2-1th idle roller and an upper end of the 2-2th idle roller.

The pinhole detection device according to an embodiment of the present invention may further include an static electricity elimination unit that is mounted on the base part, and disposed between the 2-2th idle roller and the compression roller unit to eliminate static electricity from the film passing through the 2-2th idle roller, wherein the static electricity elimination unit may adhere the film passing through the compression roller unit to an adjacent member or film by static electricity attraction.

In the pinhole detection device according to an embodiment of the present invention, the luminous intensity measuring unit may include a plurality of capturing units that are disposed to face an upper surface of the base part, while being mounted on a standing part erected from the upper surface of the base part, a determination unit that determines whether the luminance intensity measured by the plurality of capturing units is different from preset luminance intensity, a notification unit that is disposed adjacent to each of the capturing units constituting the plurality of capturing units in a one-to-one correspondence and emits light or sound according to an input signal, and a first control unit that inputs a signal to the notification unit according to a value determined by the determination unit.

In the pinhole detection device according to an embodiment of the present invention, the film supply unit may include a first mounting part and a second mounting part that are disposed to be spaced apart from each other, wherein the first mounting part and the second mounting part may be each provided with a roller, and when different types of films are mounted on the first mounting unit and the second mounting unit, the determination unit may determine information on the luminous intensity acquired by the capturing unit in a first area that captures the unwound film from the first mounting part, and information on the luminous intensity acquired by the capturing unit in a second area that captures the unwound film from the second mounting part to be different setting values.

The pinhole detection device according to an embodiment of the present invention may further include: a safety photo sensor unit that is installed on front surface or rear surface of the base part to detect a human body into the base part; an operating panel part that is installed on the base part to control the compression roller unit or the driving roller unit; and a second control unit that controls the film unwinding unit according to a value detected by the safety photo sensor unit, wherein the operating panel part includes a first panel part that is installed on a front surface of the base part and a second panel part that is seated on the ground.

The pinhole detection device according to an embodiment of the present invention may include: a film collection unit that is mounted on the base part, disposed below the film unwinding unit, and has a collection space formed therein to collect the film for which the pinhole detection is completed, wherein the film collection unit may include a collection main body part that is detachably mounted on the base part and forms the collection space, and a handle part that is formed on a front surface of the collection main body part and allows a user to separate the collection main body part from the base part while holding the handle part.

According to the present invention, it is possible to prevent the film for which the pinhole detection is completed from coming into close contact with adjacent members due to the static electricity, and to prevent the shaft of the roller from being damaged during the process of compressing and transporting the film by moving the roller.

### BRIEF DESCRIPTION OF THE DRAWINGS

FIG. 1 is a schematic perspective view showing a pinhole detection device according to an embodiment of the present invention.

FIGS. 2A, 2B and 3 are side views for describing a film unwinding unit according to an embodiment of the present invention.

FIG. 4 is a schematic perspective view showing the film unwinding unit according to an embodiment of the present invention.

FIGS. 5A and 5B are schematic perspective views shown for describing a luminous intensity measuring unit and a film collection unit according to an embodiment of the present invention.

FIGS. 6A and 6B are block diagrams shown for describing a first control unit and a second control unit according to an embodiment of the present invention.

FIG. 7 is a schematic perspective view for describing a film supply unit according to an embodiment of the present invention.

### DETAILED DESCRIPTION

Specific embodiments of the present invention will now be described in detail with reference to the accompanying drawings. However, it should be noted that the spirit of the present invention is not limited to the embodiments set forth herein and those skilled in the art who understand the spirit of the present invention can easily suggest retrogressive inventions or other embodiments included in the spirit of the present invention by the addition, modification, and removal of components within the same spirit, but those are construed as being included in the spirit of the present invention.

Further, components with the same function within the scope of the same spirit shown in the drawings of each embodiment are described using the same reference numerals.

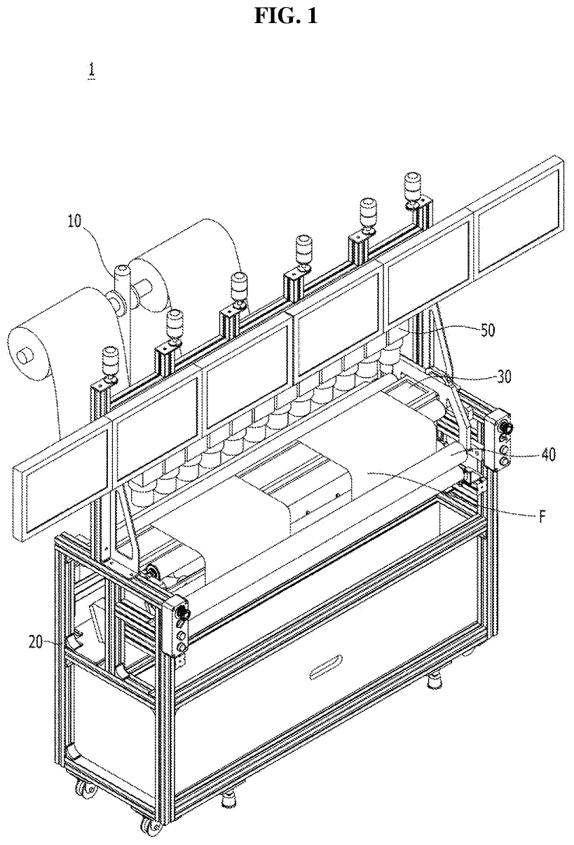

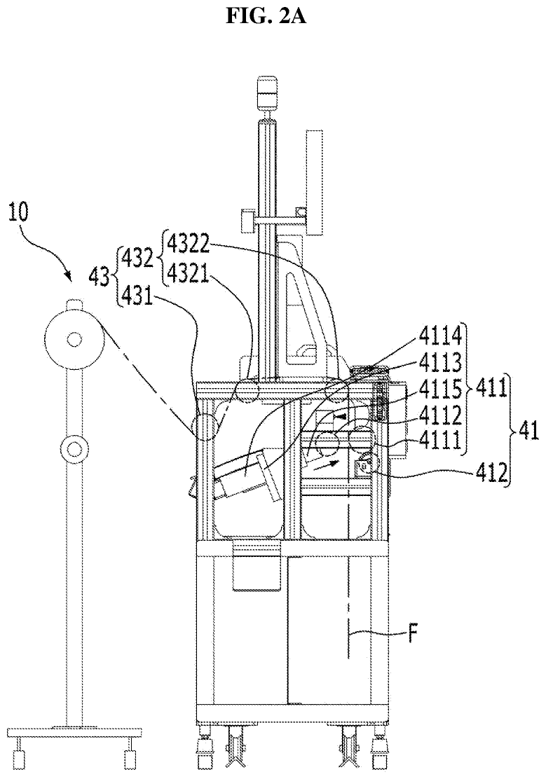

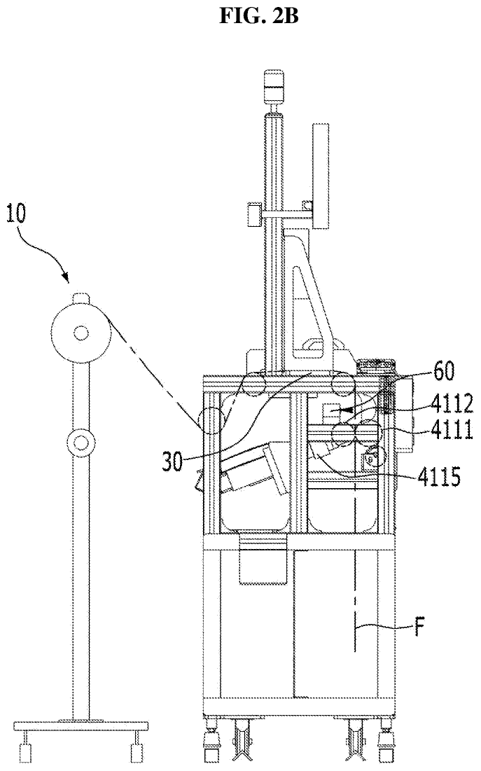

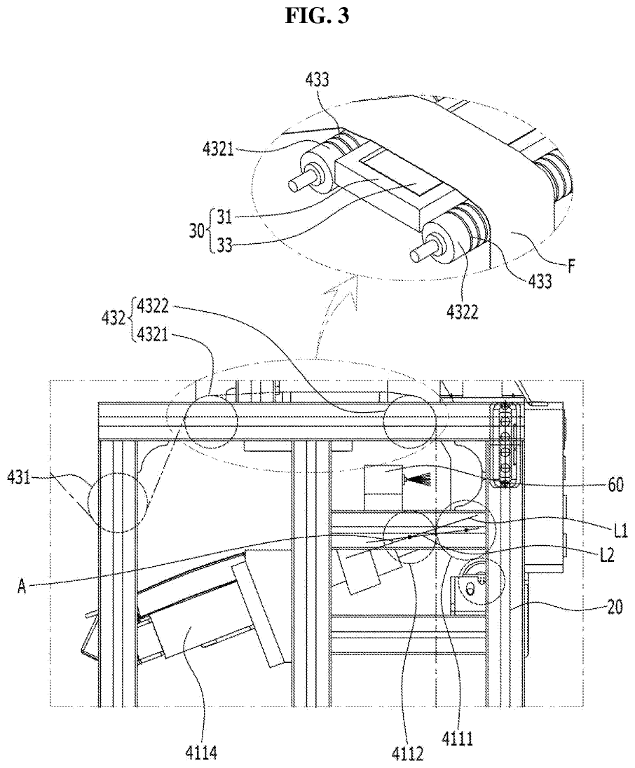

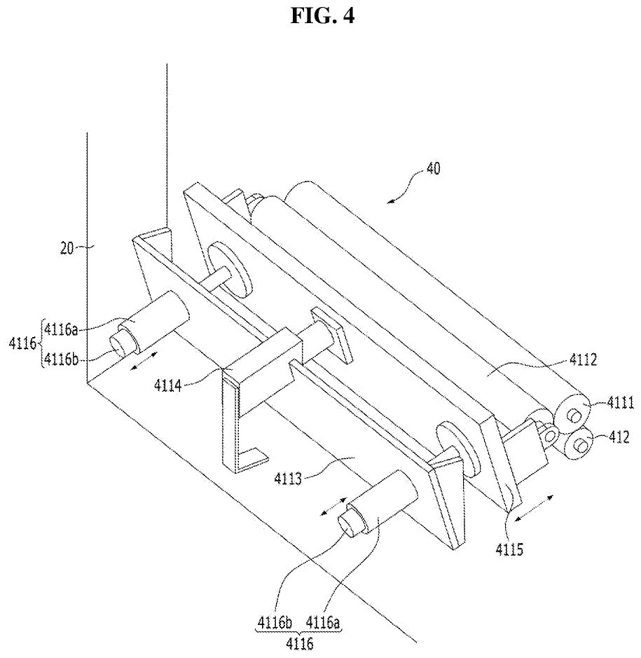

FIG. 1 is a schematic perspective view showing a pinhole detection device according to an embodiment of the present invention, FIGS. 2A, 2B and 3 are side views for describing a film unwinding unit according to an embodiment of the present invention, and FIG. 4 is a schematic perspective view showing the film unwinding unit according to an embodiment of the present invention.

Referring to FIGS. 1 to 4, a pinhole detection device 1 according to an embodiment of the present invention may be a detection device for detecting pinholes formed in a film F.

Here, the pinhole may mean a hole generated during a manufacturing process of the film F.

The pinhole detection device 1 may include a film supply unit 10, a base part 20, a light emitting unit 30, a film unwinding unit 40, and a luminous intensity measuring unit 50.

The film supply unit 10 may be provided with a roller on which the film F is wound.

The base part 20 may be disposed adjacent to the film supply unit 10, seated on the ground, and formed by connecting a plurality of profiles, and the light emitting part 30 may emit light while being mounted on the base part 20.

The film unwinding unit 40 may be mounted on the base part 20, and unwind the film F provided from the film supply unit 10 and allow the unwound film F to pass through the light emitting unit 30 while being unfolded.

The luminous intensity measuring unit 50 may be mounted on the base part 20 and disposed to face the light emitting unit 30 to measure the luminous intensity of light passing through the unfolded film F.

In the present invention, pinholes may be detected by determining whether the pinholes have been formed in the film F by measuring the luminous intensity of light passing through the unfolded film F disposed to face the light emitting unit 30, which will be described later.

The film unwinding unit 40 may include a winder roller unit 41 and an idle roller unit 43.

The winder roller unit 41 may be rotated while compressing the film F and moved in one direction, and the idle roller unit 43 may guide the unwound film F to determine its movement path.

The winder roller unit 41 may be composed of a compression roller unit 411 and a driving roller unit 412.

The compression roller unit 411 may compress the film F, and the driving roller unit 412 may be rotated by applied power while adhering to the compression roller unit 411 to rotate the adhering compression roller unit 411.

Here, the applied power may refer to a motor.

The compression roller unit 411 may include an interlocking roller 4111 that adheres to the driving roller unit 412 and a moving roller 4112 that is disposed adjacent to the interlocking roller 4111.

The interlocking roller 4111 may adhere to the driving roller unit 412 and receive rotational force of the driving roller unit 412.

The moving roller 4112 may be moved so that a separation distance from the interlocking roller 4111 is changed, and press the interlocking roller 4111 to compress the film F interposed between the moving roller 4112 and the interlocking roller 4111 (see FIG. 2B).

When the moving roller 4112 presses the interlocking roller 4111 to compress the film F interposed between the moving roller 4112 and the interlocking roller 4111, the film F may be transported by receiving the rotational force of the interlocking roller 4111.

That is, the moving roller 4112 and the interlocking roller 4111 compress the film F together and transmit the rotational force to the film F, thereby transporting the film F.

In the present invention, the moving roller 4112 directly adheres to the driving roller unit 412 and does not receive the rotational force, but receives the rotational force through the interlocking roller 4111, which is to protect a shaft of the driving roller unit 412 or a motor that rotates the driving roller unit 412.

When the moving roller 4112 directly presses the driving roller unit 412 without the interlocking roller 4111, force is directly applied to the driving roller unit 412, causing damage such as bending of the shaft of the driving roller unit 412.

In addition, when the shaft of the driving roller unit 412 is damaged, the motor that rotates the shaft of the driving roller unit 412 may be overloaded by rotating the damaged shaft, and the motor may also be damaged accordingly.

In order to prevent this, in the present invention, the interlocking roller 4111 is provided to prevent the force of the moving roller 4112 from being directly transmitted to the driving roller unit 412, thereby preventing the shaft of the driving roller unit 412 or the motor that rotates the driving roller unit 412 from being damaged.

The compression roller unit 411 may include a fixed part 4113, a position moving unit 4114, and a space providing unit 4115.

The fixed part 4113 is fixed to the base part 20, and the position moving unit 4114 may be moved by the applied power while being mounted on the fixed part 4113.

The position moving unit 4114 may be mounted on the fixed part 4113, but may be firmly supported by being mounted on the base part (20) by a separate support member (see FIG. 4).

The moving roller 4112 may be moved from a standby position to the compression position by the position moving unit 4114.

Here, the standby position refers to a position where the moving roller 4112 is disposed at a first separation distance from the interlocking roller 4111 (see FIG. 2A).

The compression position refers to a position where the moving roller 4112 is moved by the position moving unit 4114 and disposed at a second separation distance closer than the first separation distance (see FIG. 2B).

When the moving roller 4112 is positioned at the standby position, a space for inserting the film F into the compression roller unit 41 may be secured.

Specifically, before performing the pinhole detection operation, the film F should be mounted on the pinhole detection device 1. In this case, a user may position the moving roller 4112 at the standby position and then easily insert the film F into a space between the moving roller 4112 and the interlocking roller 4111.

Even if the moving roller 4112 is positioned at the compression position, the film F may be inserted between the moving roller 4112 and the interlocking roller 4111, but the space between the moving roller 4112 and the interlocking roller 4111 is narrow, making the insertion difficult, and during the insertion process, part of a user's body may become caught or entangled in the compression roller unit 41, resulting in serious injury to the user.

To prevent this, in the present invention, the moving roller 4112 may be moved and positioned at the standby position, and the user may easily insert the film F into the moving roller 4112 and the interlocking roller 4111.

The moving roller 4112 may be moved from the standby position to the compression position by the position moving unit 4114, and move the film F by compressing the film F interposed between the moving roller 4112 and the interlocking roller 4111.

The film F interposed between the moving roller 4112 and the interlocking roller 4111 may be moved only when the moving roller 4112 is positioned at the compression position and compresses the film F.

The reason is that both the moving roller 4112 and the interlocking roller 4111 should compress and hold the film F so that the rotational force of the interlocking roller 4111 may be transmitted to the film F.

Referring to FIG. 3, the first straight line L1 extending the positional movement direction of the position moving unit 4114 and a second straight line L2 connecting a first rotation axis of the moving roller 4112 and a second rotation axis of the interlocking roller 4111 forms a first angle A, and the first angle A may form an acute angle.

When the first straight line L1 and the second straight line L2 are disposed on the same straight line, the force generated by the positional movement of the moving roller 4112 is completely transmitted to the second rotation axis of the interlocking roller 4111, so the interlocking roller 411 may be separated from the base part 20 or the damage such as the bending of the second rotation axis of the interlocking roller 411 may occur.

In order to prevent this, the moving roller 4112 and the interlocking roller 4111 are disposed so that the first straight line L1 and the second straight line L2 form the acute angle with respect to each other, so the force generated by the positional movement of the moving roller 4112 is not completely transmitted to the second rotation axis of the interlocking roller 4111 but is distributed to an upper side surface of the interlocking roller 4111, thereby preventing the interlocking roller 4111 from being separated or preventing the second rotation axis of the interlocking roller 4111 from being damaged.

Referring to FIG. 4, the space providing unit 4115 is interlocked according to the positional movement of the position moving unit 4114 while being connected to the position moving unit 4114, and provides the space where the first rotation axis of the moving roller 4112 may be mounted and provides the space where the moving roller 4112 may be rotated.

The moving roller 4112 is not directly connected to the position moving unit 4114, but the space providing unit 4115 mediates the moving roller 4112 and the position moving unit 4114.

This is to mount the moving roller 4112 to be interlocked with the position moving unit 4114, but to enable the moving roller 4112 to be rotated at the compression position by receiving the rotational force by the interlocking roller 4111.

In the present invention, the space providing unit 4115 mediates the moving roller 4112 and the position moving unit 4114, the moving roller 4112 mounted on the space providing unit 4115 may be moved according to the positional movement of the position moving unit 4114, and may be rotated by receiving the rotational force from the interlocking roller 4112 at the compression position.

The compression roller unit 411 may further include a guide part 4116.

The guide part 4116 may be fixed to the fixed part 4113 and disposed on both sides of the position moving unit 4114 to guide the positional movement of the space providing unit 4115 with respect to the fixed part 4113.

Specifically, the guide part 4116 guides the position moving unit 4114 to stably move the space providing unit 4115.

The guide part 4116 may be composed of a main body part 4116a fixed to the fixed part and a rod part 4116b fixed to the space providing unit 4115.

A length of the guide part 4116 may be changed according to insertion and de-insertion of the rod part 4116b into and from the main body part 4116a.

Specifically, when the rod part 4116b is inserted into the main body part 4116a, the moving roller 4112 may be moved to the compression position, and when the rod part 4116b is de-inserted from the main body part 4116a, the moving roller 4112 may be moved to the standby position.

The idle roller unit 43 may include a first idle roller 431 and a second idle roller 432.

The film F supplied from the film supply unit 10 may pass through the first idle roller 431.

The second idle roller 432 may be disposed on both sides of the light emitting unit 30, and allow the film F passing through the first idle roller 431 to pass through an upper side of the light emitting unit 30 while being unfolded.

A height of the shaft of the first idle roller 431 may be disposed lower than the shaft of the film supply unit 10 and lower than the shaft of the second idle roller 432, with respect to the ground.

Referring to FIG. 2, the height of the shaft of the first idle roller 431 is disposed lower than the shafts of the film supply unit 10 and the second idle roller 432, so the film F may be allowed to pass through the light emitting unit 30 while maintaining tension.

The film F unwound from the film supply unit 10 may be in contact with a lower side surface of the first idle roller 431 and moved while being in contact with the upper side surface of the second idle roller 432.

The second idle roller 432 may include a 2-1th idle roller 4321 and a 2-2th idle roller 4322.

The 2-1th idle roller 4321 may be disposed on one side of the light emitting portion 30 in a width direction, and the 2-2th idle roller 4322 may be disposed on the other side of the light emitting portion 30 in a width direction.

The 2-1th idle roller 4321 and the 2-2th idle roller 4322 may be disposed at the same height, and the compression roller unit 411 may be disposed below the 2-2th idle roller 4322.

The film F supplied from the film supply unit 10 may be compressed by the compression roller unit 411 while passing through the first idle roller 431 and the second idle roller 432 to maintain tension.

Referring to the enlarged view of FIG. 3, the 2-1th idle roller 4321, and the 2-2th idle roller 4322 may be provided with a plurality of display portions 433 formed at regular intervals along an outer peripheral surface.

A user may determine based on the display unit 433 whether the film is unwound without being distorted.

In addition, the luminous intensity measuring unit 50 may measure the luminous intensity of light passing through the film F only in the measurement area, and cannot measure the luminous intensity of light passing through the film F outside the measurement area.

In the present invention, in order to allow the user to easily determine whether the film F is outside the measurement area of the luminous intensity measuring unit 50, the user may match the position of the display portion 433 closest to the ends of the 2-1th idle roller 4321 and the 2-2th idle roller 4322 with the end of the measurement area of the luminous intensity measuring unit 50, and may easily detect when the film F is outside the measurement area of the luminous intensity measuring unit 50.

Referring to the enlarged view of FIG. 3, the light emitting part 30 may be composed of a seating part 31 and an LED unit 33.

The seating part 31 may be seated on the upper surface of the base part 20, and may be disposed between the 2-1th idle roller 4321 and the 2-2th idle roller 4322, and the LED unit 33 may be built in the seating part 31.

The seating part 31 may be formed higher than an upper end of the 2-1th idle roller 4321 and an upper end of the 2-2th idle roller 4322.

When the seating part 31 is formed lower than the 2-1th idle roller 4321 and the 2-2th idle roller 4322, the film F passing through the upper side of the seating part 31 may be difficult to detect pinholes due to shaking up and down or not receiving light from the LED unit 33 properly.

To prevent this, the seating part 31 in the present invention is formed higher than the 2-1th idle roller 4321 and the 2-2th idle roller 4322, so the film F passing through the upper sides of the 2-1th idle roller 4321 and the 2-2th idle roller 4322 may be moved while adhering to the upper surface 31 of the seating part.

FIG. 3 shows that the LED unit 33 is formed lower than the seating part 31. However, the LED unit 33 may be formed at the same height as the seating part 31.

According to another embodiment of the present invention, the seating part 31 may be formed to have a corner adjacent to the 2-1th idle roller 4321 and a corner adjacent to the 2-2th idle roller 4321 to be rounded.

This is to prevent the film F, which adheres to and passes through the upper surface of the seating part 31, from being damaged by the corners of the seating part 31.

In addition, a ruler capable of measuring the length along the width direction may be installed on the upper surface of the seating part 31, so that the user may measure a width size of the film F which is being detected.

The pinhole detection device 1 according to an embodiment of the present invention may further include a static electricity elimination unit 60.

Referring to FIG. 3, the static electricity elimination unit 60 may be mounted on the base part 20 and disposed between the 2-2th idle roller 4322 and the compression roller unit 411, thereby eliminating static electricity from the film F passing through the 2-2th idle roller 4322.

Specifically, the static electricity elimination unit 60 may eliminate the static electricity from the film F passing through the 2-2th idle roller 4322, thereby preventing the film F passing through the compression roller unit 411 from adhering to adjacent members or films due to static electricity attraction.

Since the films F passing through the compression roller unit 411 no longer maintain tension, the films F may adhere to adjacent members or entangle with each other due to static electricity. In order to prevent this, the static electricity elimination unit 60 may be provided to eliminate the static electricity from the film F passing through the compression roller unit 411.

In addition, the outer peripheral surfaces of the moving roller 4112 and the interlocking roller 4111 may be coated with an anti-electrostatic urethane material to prevent the static electricity from being generated in the film F passing through the compression roller unit 411.

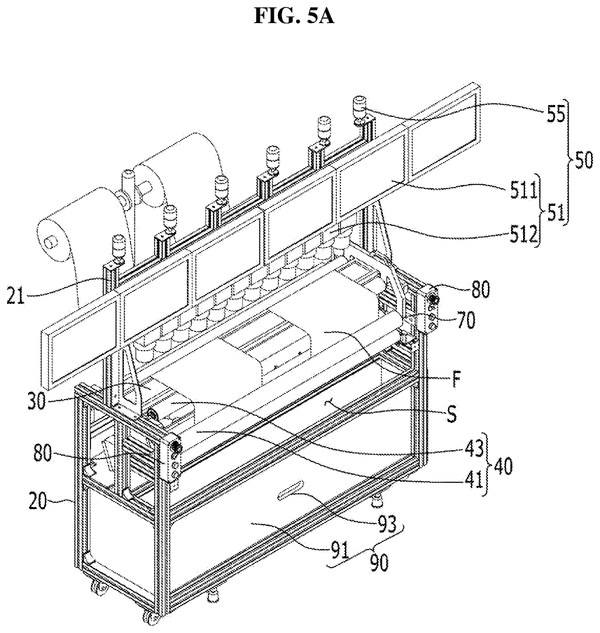

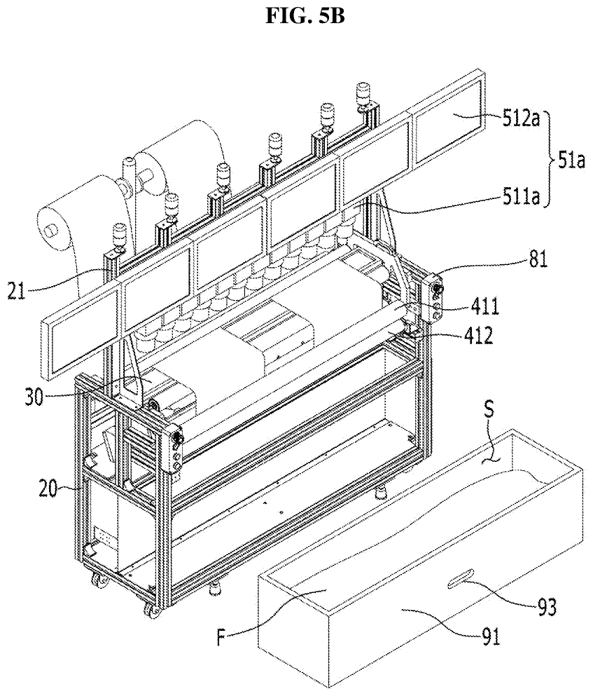

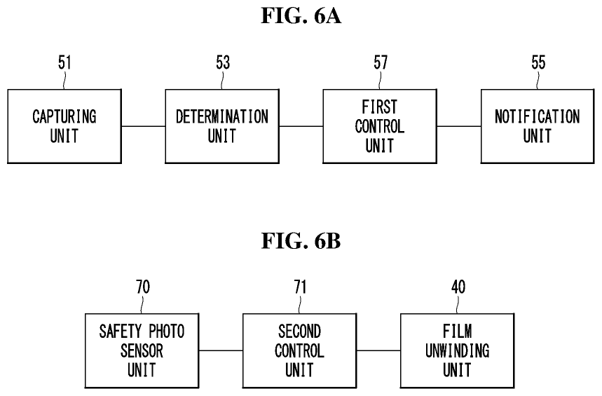

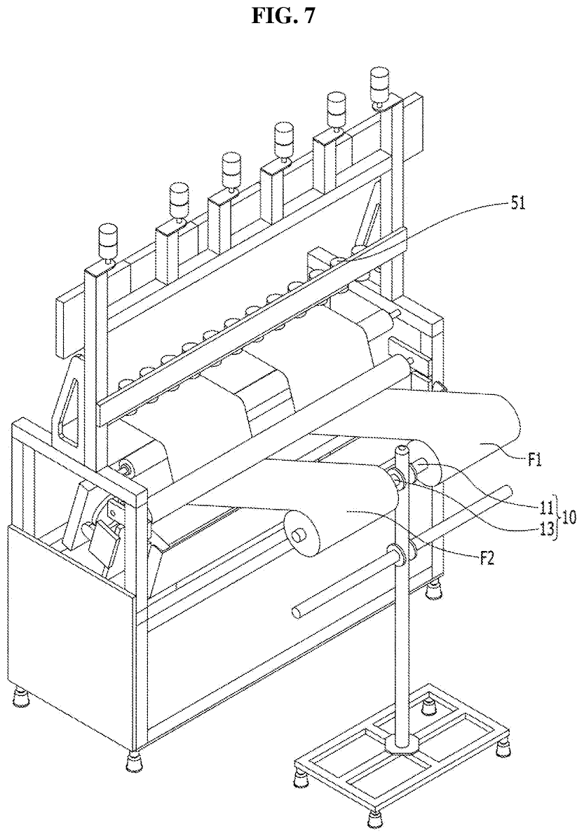

FIGS. 5A and 5B are schematic perspective views shown for describing a luminous intensity measuring unit and a film collection unit according to an embodiment of the present invention, FIGS. 6A and 6B are block diagrams shown for describing a first control unit and a second control unit according to an embodiment of the present invention, and FIG. 7 is a schematic perspective view for describing a film supply unit according to an embodiment of the present invention.

Referring to FIGS. 5A to 7, the luminous intensity measuring unit 50 according to an embodiment of the present invention may include a plurality of capturing units 51, a determination unit 53, a notification unit 55, and a first control unit 57.

The plurality of capturing units 51 may be disposed to face the upper surface of the base part 20 while being mounted on a standing part 21 erected from the upper surface of the base part 20.

Specifically, the plurality of capturing units 51 include an image acquisition unit 511 that captures the film F passing through the light emitting unit 30 and measures the luminous intensity of light passing through the film F, and an image providing unit 512 that provides the image captured by the image acquisition unit 511 to the user.

The image acquisition unit 511 is composed of a plurality of cameras 511a, and the image providing unit 512 is composed of a plurality of screens 512a.

The screen 512a corresponds to a plurality of cameras 511a that captures a certain area, and may provide images captured by the plurality of cameras 511a to the user.

That is, one screen 512a may be provided with the plurality of images each captured by the plurality of cameras 511a corresponding to the screen 512a.

Describing based on the contents described above, each capturing unit 51a constituting the plurality of capturing units 51 may be composed of the plurality of cameras 511a and the corresponding screen 512a.

The determination unit 53 may determine whether the luminous intensity measured by the plurality of capturing units 51 is different from the preset luminous intensity.

Here, the preset luminous intensity may refer to the luminous intensity value of light passing through the film F in which the pinholes are not formed.

Specifically, when the luminous intensity measured by the plurality of capturing units 51 is different from the preset luminous intensity, the determination unit 53 may determine that the pinholes occurred.

The notification unit 55 may be disposed adjacent to each of the capturing units 51a constituting the plurality of capturing units 51 in a one-to-one correspondence, and emit light or sound according to an input signal.

Specifically, the notification unit 55 may be disposed adjacent to the screen 512a in a one-to-one correspondence.

The first control unit 57 may input a signal to the notification unit 55 according to the value determined by the determination unit 53.

Specifically, when the determination unit 53 determines that the luminous intensity measured by the capturing unit 51a is different from the preset luminous intensity, the first control unit 57 may input the signal to the notification unit 55 corresponding to the capturing unit 51a in which the luminous intensity different from the preset luminous intensity is measured so that the notification unit 55 may emit the light or sound.

Referring to FIG. 7, the film supply unit 10 according to an embodiment of the present invention may include a first mounting part 11 and a second mounting part 13.

The first mounting part 11 and the second mounting part 13 may be disposed to be spaced apart from each other, and each of the first mounting part 11 and the second mounting part 13 may be provided with a roller on which the film F is wound.

When different types of films F are mounted on the first mounting unit 11 and the second mounting unit 13, the determination unit 53 may determine information on the luminous intensity acquired by the capturing unit 51 in a first area that captures the film F1 unwound from the first mounting part 11, and information on the luminous intensity acquired by the capturing unit 51 in a second area that captures the film F2 unwound from the second mounting part 13 to be different setting values.

Specifically, different types of films may be mounted on the first mounting part 11 and the second mounting part 13. In this case, the types of mounted films are different, so the luminous intensity value that determines whether the pinholes are detected should also be set differently.

For this reason, the determination unit 53 determines whether there are the pinholes based on different setting values when detecting the pinholes formed in the film F1 unwound from the first mounting part 11 and the film F2 unwound from the second mounting part 13.

The pinhole detection device 1 according to an embodiment of the present invention may further include a safety photo sensor unit 70, a second control unit 71, and an operating panel part 80.

The safety photo sensor unit 70 may be installed on the front surface or rear surface of the base part 20 to detect a human body into the base part 20.

The second control unit 71 may control the film unwinding unit 40 according to the value detected by the safety photo sensor 70.

Specifically, when the safety photo sensor unit 70 detects the human body, the second control unit 71 may control the film unwinding unit 40 to stop the driving of the film unwinding unit 40.

This is to prevent injury due to part of a worker's body becoming entangled or caught between the film unwinding units 40.

The operating panel part 80 is installed on the base part 20 and may control the compression roller unit 411 or the driving roller unit 412.

The operating panel part 80 may include a first panel part 81.

The first panel part 81 is installed on the front surface of the base part 20 and may control the compression roller unit 411 to move forward or backward, and may control the driving roller unit 412 to rotate forward or reverse.

The user may control the compression roller unit 411 or the driving roller unit 412 by manually manipulating the first panel part 81 as needed.

In addition, a second panel part (not shown) mounted on the ground is further provided so that the user may control the compression roller unit 411 or the driving roller unit 412 using his or her feet.

The pinhole detection device 1 according to an embodiment of the present invention may further include a film collection unit 90.

The film collection unit 90 may be separately mounted on the base part 20, and disposed below the film unwinding unit 40, and have a collection space S formed therein to collect the film F for which pinhole detection has been completed.

The film collection unit 90 may include a collection main body part 91 and a handle part 93.

The collection main body part 91 may be separately mounted on the base part 20, and have the collection space S formed therein.

The handle part 93 may be formed on the front surface of the collection main body part 91 and allow the user to separate the collection main body part 91 from the base part while holding the handle part.

Specifically, when more than a certain amount of film S for which the pinhole detection has been completed is collected in the collection space S, the user may grip the handle part 93 to separate the collection main body part 91 from the base part 20 and empty the collection space S.

In the above, although the configuration and features of the present invention has been described based on the embodiments according to the present invention, the present invention is not limited thereto, and it is apparent to those skilled in the art that various modifications and variations can be made within the technical spirit and scope of the present invention, and therefore, it is stated that such modifications and variations fall within the scope of the appended claims.

1. A pinhole detection device for detecting pinholes formed in a film, comprising:
a film supply unit provided with a roller on which the film is wound;
a base part disposed adjacent to the film supply unit, seated on a ground, and formed by connecting a plurality of profiles;
a light emitting unit mounted on the base part and emitting light;
a film unwinding unit mounted on the base part, configured to unwind the film provided from the film supply unit, and allow the unwounded film to pass through the light emitting unit while being unfolded; and
a luminous intensity measuring unit mounted on the base part and disposed to face the light emitting unit to measure the luminous intensity of light passing through the unfolded film,
wherein the film unwinding unit includes a winder roller unit rotating and moving the film in one direction while compressing the film, and an idle roller unit rotated according to movement of the contacted film and configured to guide the unwound film to determine a movement path.

2. The pinhole detection device of claim 1, wherein the winder roller unit includes:
a compression roller unit compressing the film, and
a driving roller unit that-rotated by applied power while adhering to the compression roller unit to rotate the adhering compression roller unit,
wherein the compression roller unit has an interlocking roller adhering to the driving roller unit and a moving roller disposed adjacent to the interlocking roller, and
the moving roller is moved so that a separation distance from the interlocking roller changes to compress or decompress the film interposed between the moving roller and the interlocking roller.

3. The pinhole detection device of claim 2, wherein the compression roller unit further includes:
a fixed part fixed to the base part;
a position moving unit moved by the applied power while being mounted on the fixed part; and
a space providing unit interlocked according to positional movement of the position moving unit while being connected to the position moving unit, and configured to provide a space where a first rotation axis of the moving roller is mounted,
wherein the moving roller is moved by the position moving unit from a standby position disposed at a first separation distance from the interlocking roller to a compression position disposed at a second separation distance closer than the first separation distance, and
a first straight line extending a positional movement direction of the position moving unit and a second straight line connecting the first rotation axis of the moving roller and a second rotation axis of the interlocking roller form an acute angle.

4. The pinhole detection device of claim 3, wherein the compression roller unit further includes a guide part fixed to the fixed part and disposed on both sides of the position moving unit to guide positional movement of the space providing unit with respect to the fixed part, and
wherein the guide part is composed of a main body part that is fixed to the fixed part and a rod part that is fixed to the space providing unit, and a length of the guide part changes according to insertion and de-insertion of the rod part into and from the main body part.

5. The pinhole detection device of claim 2, wherein the idle roller unit includes:
a first idle roller through which the film supplied from the film supply unit passes; and
second idle rollers disposed on both sides of the light emitting unit and configured to allow the film passing through the first idle roller to pass through an upper side of the light emitting unit while being unfolded,
wherein a height of a shaft of the first idle roller is disposed lower than a shaft of the film supply unit and lower than a shaft of the second idle roller, with respect to the ground, and
the film unwound from the film supply unit is in contact with a lower side of the first idle roller and an upper side of the second idle roller.

6. The pinhole detection device of claim 5, wherein the second idle roller includes a 2-1th idle roller disposed on one side of the light emitting unit in a width direction and a 2-2th idle roller disposed on the other side of the light emitting unit in the width direction,
wherein the 2-1th idle roller and the 2-2th idle roller are disposed at the same height,
the compression roller unit is disposed below the 2-2 idle roller, and
the film supplied from the film supply unit is compressed by the compression roller unit while passing through the first idle roller and the second idle roller to maintain tension.

7. The pinhole detection device of claim 6, wherein the light emitting unit is composed of a seating part seated on an upper surface of the base part and disposed between the 2-1th idle roller and the 2-2th idle roller and an LED unit built in the seating part, and
the seating part is formed higher than an upper end of the 2-1th idle roller and an upper end of the 2-2th idle roller.

8. The pinhole detection device of claim 6, further comprising:
a static electricity elimination unit mounted on the base part, and disposed between the 2-2th idle roller and the compression roller unit to eliminate static electricity from the film passing through the 2-2th idle roller,
wherein the static electricity elimination unit adheres the film passing through the compression roller unit to an adjacent member or film by static electricity attraction.

9. The pinhole detection device of claim 2, wherein the luminous intensity measuring unit includes:
a plurality of capturing units disposed to face an upper surface of the base part, while being mounted on a standing part erected from the upper surface of the base part,
a determination unit configured to determine whether the luminance intensity measured by the plurality of capturing units is different from preset luminance intensity,
a notification unit disposed adjacent to each of the capturing units constituting the plurality of capturing units in a one-to-one correspondence, and configured to emit light or sound according to an input signal, and
a first control unit configured to input a signal to the notification unit according to a value determined by the determination unit.

10. The pinhole detection device of claim 9, wherein the film supply unit includes a first mounting part and a second mounting part disposed to be spaced apart from each other,
wherein the first mounting part and the second mounting part are each provided with a roller, and
when different types of films are mounted on the first mounting unit and the second mounting unit, the determination unit determines information on the luminous intensity acquired by the capturing unit in a first area that captures the film unwound from the first mounting part, and information on the luminous intensity acquired by the capturing unit in a second area that captures the film unwound from the second mounting part to be different setting values.

11. The pinhole detection device of claim 2, further comprising:
a safety photo sensor unit installed on front surface or rear surface of the base part to detect a human body into the base part;
an operating panel part installed on the base part to control the compression roller unit or the driving roller unit; and
a second control unit configured to control the film unwinding unit according to a value detected by the safety photo sensor unit,
wherein the operating panel part includes:
a first panel part installed on a front surface of the base part, and
a second panel part seated on the ground.

12. The pinhole detection device of claim 1, further comprising:
a film collection unit mounted on the base part, disposed below the film unwinding unit, and having a collection space formed therein to collect the film for which the pinhole detection is completed,
wherein the film collection unit includes:
a collection main body part detachably mounted on the base part and configured to form the collection space, and
a handle part formed on a front surface of the collection main body part and configured to allow a user to separate the collection main body part from the base part while holding the handle part.
